(19) United States
(12) Patent Application Publication
(10) Pub. No.: US 2008/0165760 A1
(43) Pub. Date: Jul. 10, 2008

(54) Method and Apparatus For Optimizing Flow Control Over Wlans

(75) Inventors: Kiran S. Challapali, New City, NY (US); Lluis Llavina Serra, Barcelona (ES)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/720,361

(22) PCT Filed: Nov. 28, 2005
(86) PCT No.: PCT/IB05/53936

§ 371 Date: May 29, 2007

Related U.S. Application Data
(60) Provisional application No. 60/631,843, filed on Nov. 30, 2004.

(51) Int. Cl. H04J 3/24

(52) U.S. Cl. 370/349

(57) ABSTRACT

A method and apparatus for determining a period for transmitting a video stream comprising a plurality of base layers (110) and corresponding enhancement layers (115) is disclosed. The method comprises the steps of obtaining a measure of channel condition, transmitting each of said base layers (110) for a predetermined time period and transmitting a corresponding enhancement layer (115) for a period determined based on said measure of channel condition and said base layer time period. In one aspect of the invention, the base layer time period and the enhancement layer period are less than a critical time period.

This invention is directed to wireless communications and more specifically to a method and system for optimizing the data flow across a wireless network.

Conventional wireless transmitters have a video encoder that generates a multi-layer variable rate digital video stream containing data packets identified as base layer (BL) packets and enhancement layer (EL) packets. The BL layer packets contain data that is critical for decoding the video stream and viewing a basic image, while the enhancement layer packets contain data that improves the quality of the received video stream. The packets in each video frame (BL and EL) are transmitted before the frames of a subsequent frame. However, the number of packets (BL or EL) that can be transmitted depends on the channel conditions. Furthermore, the packets for each frame have to arrive at a receiver decoder by a predetermined decoding time in order to be available for decoding the video frame. If packets arrive after the decoding time, the packets will not be available for decoding and, hence, not contribute to the decoded picture.

Thus, there is a critical time after which packets for a frame that are not yet transmitted provide no additional information to the image because these packets will not arrive at the decoder by the frame decoding time. Because for each video packet, BL data packets are transmitted before EL data packets, data elements within the EL packets are more likely to be dropped when the critical frame time is exceeded. Conventional methods for determining which EL data packets are not transmitted or dropped are complex or computationally expensive or require additional information, e.g., accurate channel state information.

Hence, there is a need in the industry for a method and system that provides a simple means for determining when not to transmit or drop EL data packets to optimize the data stream transmission process.

A method and apparatus for determining a period for transmitting a video stream comprising a plurality of base layers and corresponding enhancement layers is disclosed. The method comprises the steps of obtaining a measure of channel condition, transmitting each of said base layers for a predetermined time period and transmitting a corresponding enhancement layer for a period determined based on said measure of channel condition and said base layer time period. In one aspect of the invention, the base layer time period and the enhancement layer period are less than a critical time period.

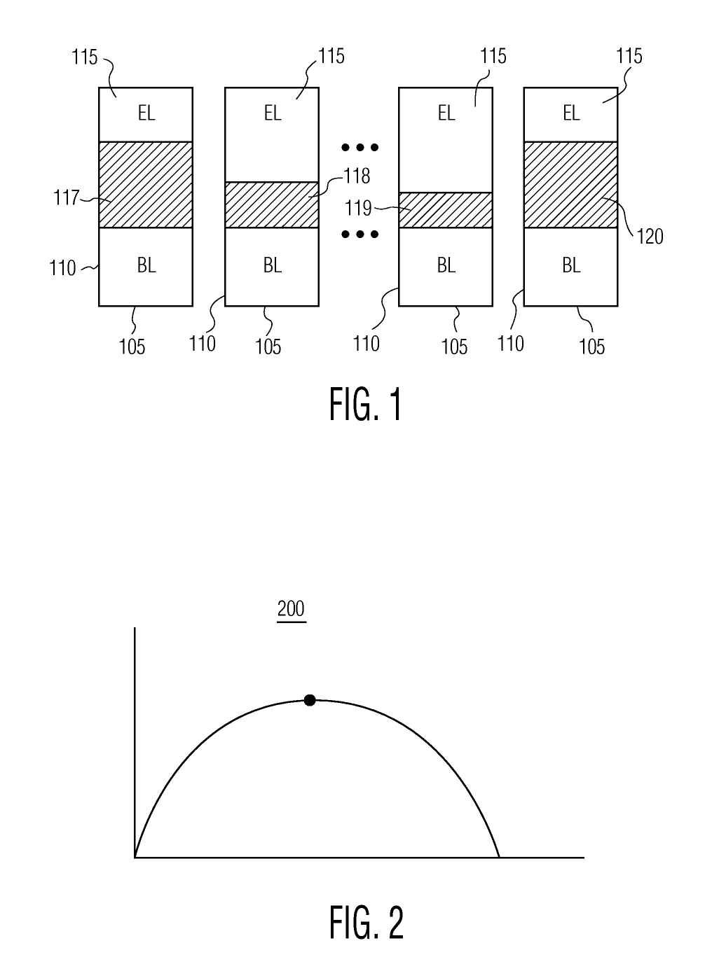

FIG. 1 illustrates a conventional digitized video stream;

FIG. 2 illustrates a chart of picture quality with regard to EL transmission period in accordance with the principles of the invention;

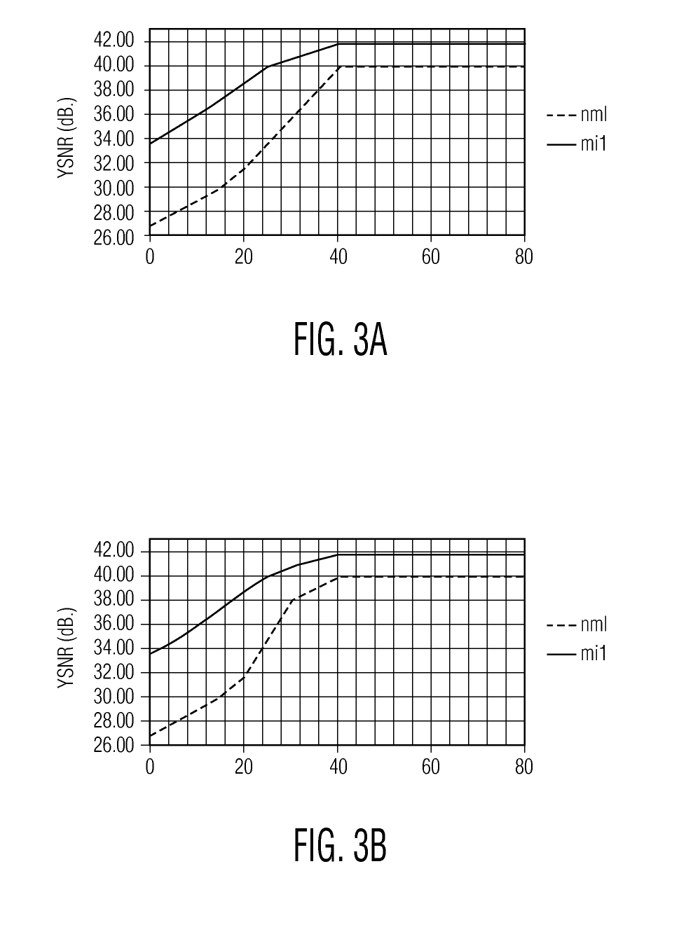

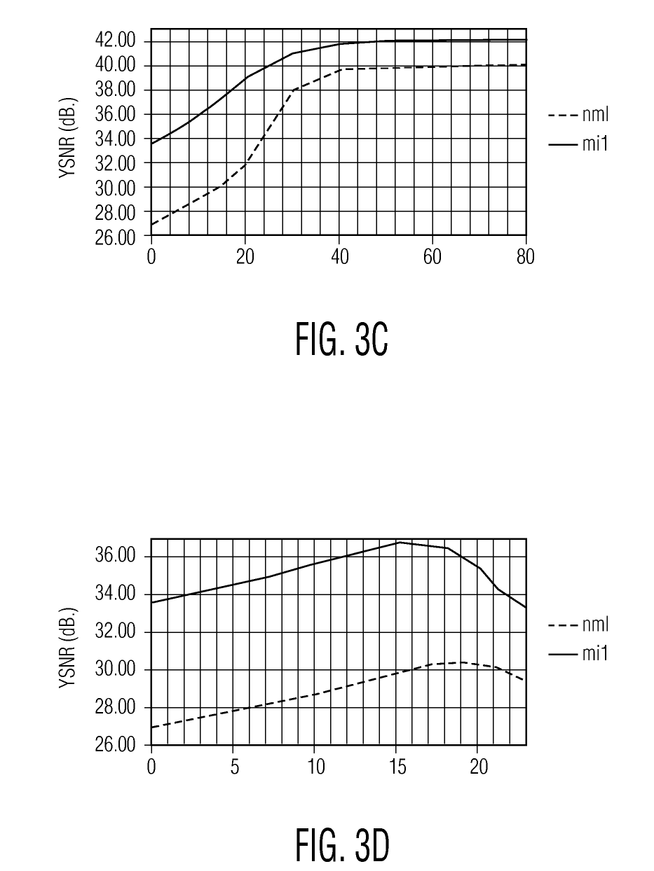

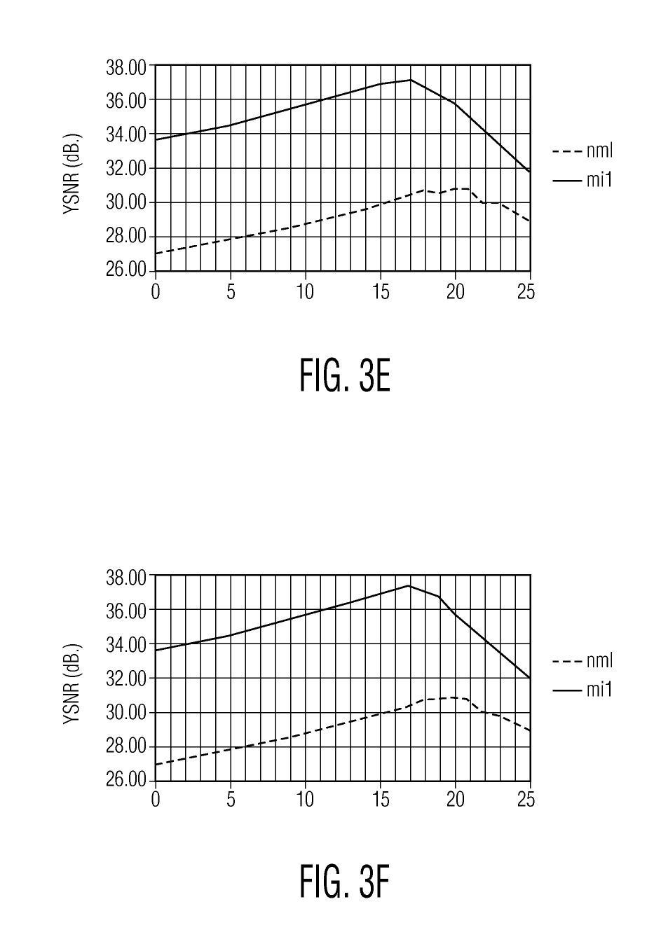

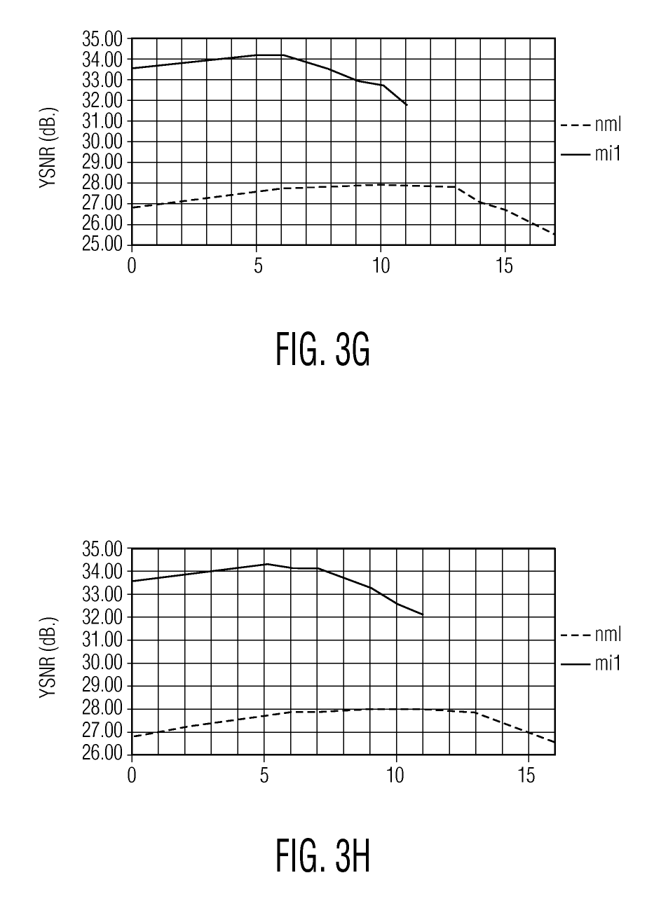

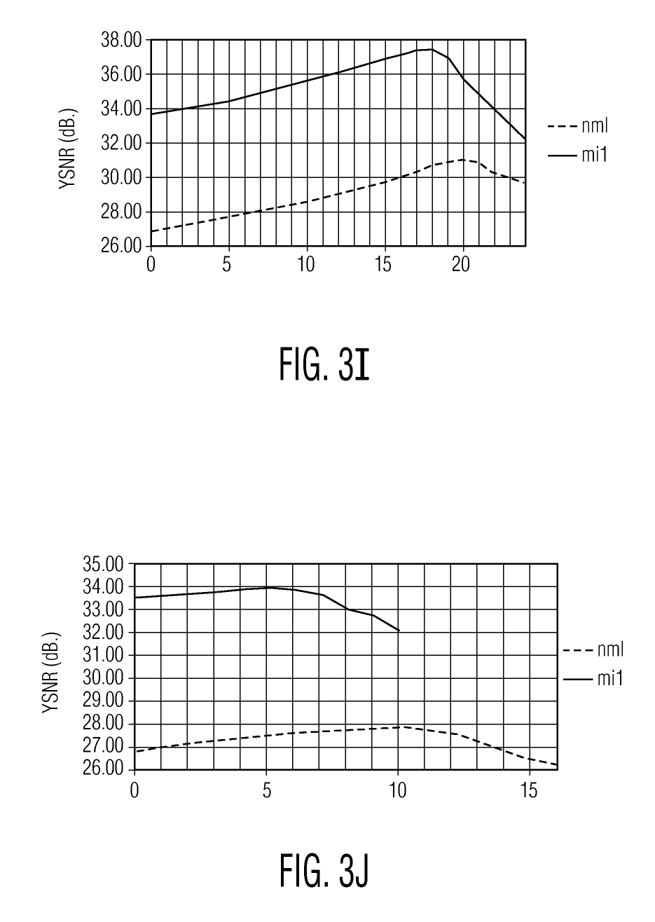

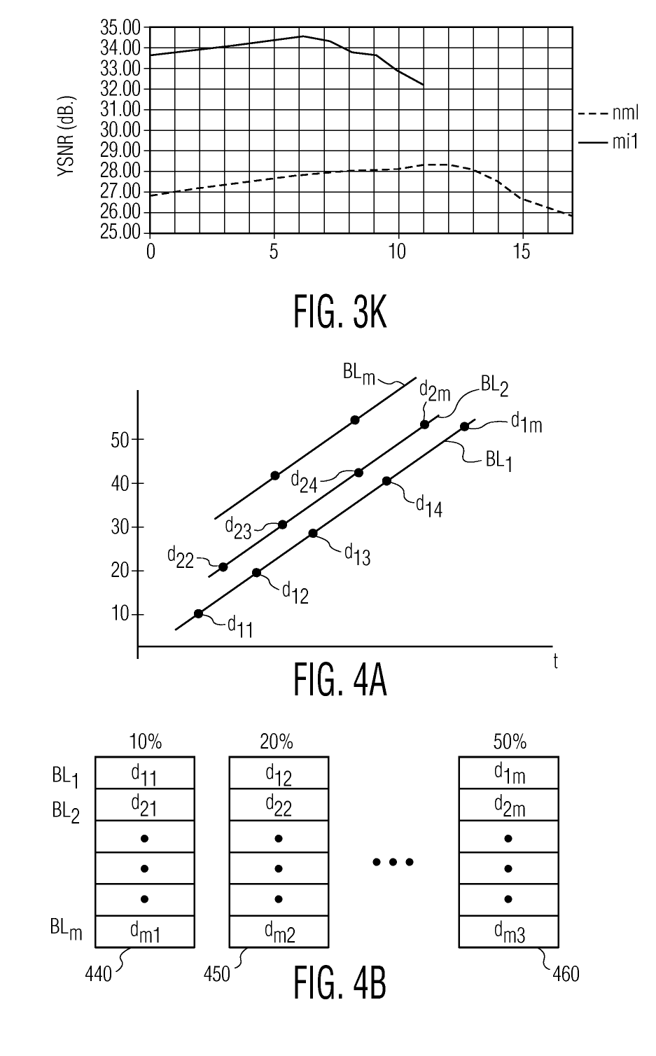

FIGS. 3a-3k illustrate exemplary determinations of image quality as a function of Enhanced Layer transmission period;

FIG. 4a illustrates a chart of image quality verses Enhanced Layer transmission duration with regard to channel conditions and BL transmission duration;

FIG. 4b illustrates an exemplary implementation of the information shown in FIG. 4a;

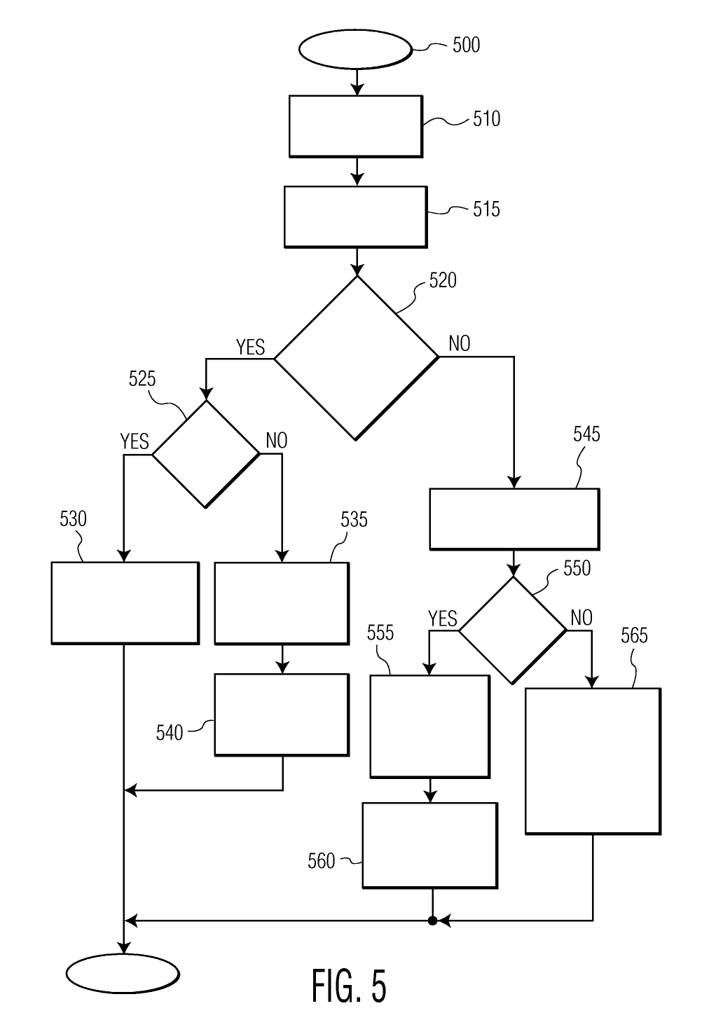

FIG. 5 illustrates a flow chart of an exemplary processing for determining a flow control value in accordance with the principles of the invention; and

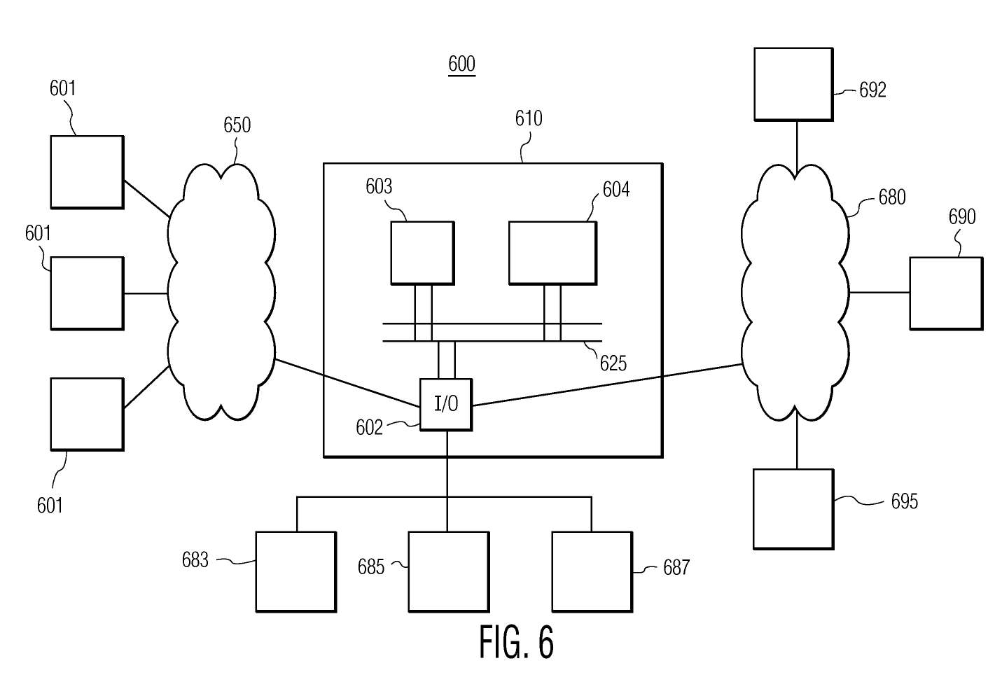

FIG. 6 illustrates an apparatus for executing the processing shown herein.

It is to be understood that these drawings are for purposes of illustrating the concepts of the invention and are not to scale. It will be appreciated that the same reference numerals, possibly supplemented with reference characters where appropriate, have been used throughout to identify corresponding parts.

FIG. 1 illustrates a conventional video stream comprising a plurality of video frames 105 and each frame containing BL 110 and EL 115. BL 110 represents the minimum level of data transmitted, while the amount of data transmitted in each EL 115 depends, in part, on the conditions of the transmission channel. Thus, the full amount of each EL 115 may not be transmitted. Regions 120 shown within EL 115 illustrate examples of the amount of data that, because of changes in the transmission channel conditions, may be transmitted. Hence, the number of EL packets, and consequently, the quality of the received image may change as the data transmitted in the video stream varies.

FIG. 2 illustrates an exemplary representation of picture visual quality (PSNR) with regard to time of transmission of the EL packets. As shown there is an optimum point 210 at which the picture quality is maximized with regard to the time of transmission of the EL packets. Accordingly, in one aspect of the invention, the number of packets, i.e., the amount of data in an EL layer transmitted, may be limited to a predetermined time after the BL data has been transmitted.

FIGS. 3a-3k illustrate simulation results of image quality as a function of EL packet transmission time, BL transmission time and channel conditions (i.e., Percentage Packet Error Probability). FIG. 3a illustrates that for a zero percent (0%) packet error probability and the base layer transmitted for 250 ms, the image quality does not significantly improve if the EL packets are transmitted for a period greater than 40 milliseconds (ms) after the Base Layer is transmitted. FIG. 3b, similarly, illustrates that image quality does not significantly improve if EL packets are transmitted for a period greater than 40 ms when the channel condition contains 10% packet error probability and the base layer is transmitted for 250 ms. Similar determinations of a time value to limit EL packet transmission may be made with reference to FIGS. 3c-3k.

FIG. 4a illustrates a chart 400 of the exemplary results of shown in FIGS. 3a-3k, wherein image quality is plotted as a function of Enhanced Layer transmission duration (t) and Base Layer transmission duration. As one skilled in the art would recognize, the Enhanced Layer transmission values, i.e., d₁₁, d₁₂, d₂₂, d₂₃, etc., associated with each of Base Layer, i.e., BL₁, BL₂, BLₙ, transmission durations may be selected based on the information shown in FIGS. 3a-3k or may include other results that may be obtained by simulation or actual measurement. Such determinations are well within those skilled in the art and need not be discussed in detail herein.

FIG. 4b illustrates an exemplary data structure for implementing the chart shown in FIG. 4a. In this illustrated example, each data structure 440, 450, 460, etc. may represent a channel condition, i.e., packet error probability etc. For example, data structure 440 may represent information items (EL layer transmission time, d₁₁, d₁₂, etc.) associated with channel condition 10% packet error probability. Similarly, data structure 450 may represent information items (EL layer transmission time, d₂₁, d₂₂, etc.) associated with channel condition 20% packet error probability. Each entry in a data structure may represent a time value (d) associated with the transmission period of EL packets with respect to a reference BL time duration. Hence, value d₁₁, for example, which is associated with BL₁ is shown as the first element in data structure 440, i.e. 10% packet error probability. Similarly, d₁₂ is the second element in data structure 440.

In one aspect of the invention, a EL layer transmission value (d) may be selected based on the channel condition and the BL packet transmission duration. In another aspect of the invention, a transmission value (d) may be determined based on the channel condition and an interpolation between known BL packet transmission duration values, when the actual BL packet transmission duration fails to match the BL values used to construct the data structure. In still another aspect of the invention, a transmission value (d) may be determined by interpolating between channel conditions and/or an interpolation between known BL packet transmission duration values.

FIG. 5 illustrates a flow chart of an exemplary process for determining a value (d) for limiting EL layer transmission to optimize flow control in accordance with the principles of the invention. In this exemplary process, the media (channel) condition is determined at block 510. This may, for example, be determined based on known or determined criteria. At block 515, the Base Layer time determination, referred to as BL(t), is obtained. At block 520 a determination is made whether the media (channel) condition matches one of the stored condition values. If the answer is in the affirmative, then a determination is made at block 525 whether the BL(t) matches a Base Layer duration value that is used as a reference value to store EL layer time duration, referred to as EL(t). If the answer is in the affirmative, then the stored EL(t) value is obtained at block 530.

However, if the answer is in the negative, then at block 535 stored EL values, e.g., d₁₁, d₁₂, etc., associated with Base Layer reference values mathematically adjacent the determined BL(t) are obtained. At block 540, an EL(t) value is then determined based on the obtained EL values. In one aspect of the invention, the EL(t) value may be determined based on an interpolation of the obtained EL values. In another aspect of the invention, the EL(t) value may be determined as an average of the obtained EL values. In still another aspect of the invention, the EL(t) value may be determined as a function of the obtained EL values.

Returning to the determination at block 520, if the answer is in the negative, then information items regarding mathematically adjacent media (channel) conditions are obtained at block 545. At block 550, a determination is made whether the BL(t) matches any reference Base Layer transmission values. If the answer is in the affirmative, then at block 555 EL values associated with matching reference Base Layer transmission values of mathematically adjacent channel conditions are obtained. At block 560, an EL(t) value is determined based on the obtained EL values, as previously described.

However, if the answer is in the negative, then at block 565, an EL(t) value is determined based on EL values associated with the mathematically adjacent channel condition and mathematically adjacent reference Base Layer transmission values.

FIG. 6 illustrates an exemplary embodiment of a system 600 that may be used for implementing the principles of the present invention. System 600 may contain one or more input/output devices 602, processors 603 and memories 604. I/O devices 602 may access or receive information from one or more sources 601. Client devices 601 may be devices such as computers, notebook computer, PDAs, cells phones or other devices suitable for providing information to execute the processing shown herein. Devices 601 may access one or more network 650, for example, a wireless wide area network, a wireless metropolitan area network, a wireless local area network, a terrestrial broadcast system (Radio, TV), a satellite network, a cell phone, or a wireless telephone network, as well as portions or combinations of these and other types of networks to provide information to input/output device 602.

Input/output devices 602, processors 603 and memories 604 may communicate over a communication medium 625. Communication medium 625 may represent, for example, a bus, a communication network, one or more internal connections of a circuit, circuit card or other apparatus, as well as portions and combinations of these and other communication media. Input data from the client devices 601 is processed in accordance with one or more programs that may be stored in memories 604 and executed by processors 603. Processors 603 may be any means, such as general purpose or special purpose computing system, or may be a hardware configuration, such as a laptop computer, desktop computer, a server, handheld computer, dedicated logic circuit, or integrated circuit. Processors 603 may also be Programmable Array Logic (PAL), Application Specific Integrated Circuit (ASIC), etc., which may be hardware “programmed” to include software instructions or code that provides a known output in response to known inputs. In one aspect, hardware circuitry may be used in place of, or in combination with, software instructions to implement the invention. The elements illustrated herein may also be implemented as discrete hardware elements that are operable to perform the operations shown using coded logical operations or by executing hardware executable code. Memories 604 may be any semiconductor memory such as PROM, EPROM, EEPROM or RAM that is external to processor 603, and/or may be integrated with processor 603, i.e., cache. Memory 604 may also be an optical memory media.

In one aspect, the principles of the present invention may be implemented by computer readable code executed by processor 603. The code may be stored in the memory 604 or read/downloaded from a memory medium 683, an I/O device 685 or magnetic, optical media such as a floppy disk, a CD-ROM or a DVD, 687.

Information items from device 601 received by I/O device 602 after processing in accordance with one or more software programs operable to perform the functions illustrated herein may also be transmitted over network 680 to one or more output devices represented as reporting device 690, display 692 or second processing system 695.

As one skilled in the art would recognize, the term computer or computer system may represent one or more processing units in communication with one or more memory units and other devices, e.g., peripherals, connected electronically to and communicating with the at least one processing unit. Furthermore, the devices may be electronically connected to the one or more processing units via internal busses, e.g., ISA bus, microchannel bus, PCI bus, PCMCIA bus, etc., or one or more internal connections of a circuit, circuit card or other device, as well as portions and combinations of these and other communication media or an external network, e.g., the Internet and Intranet.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention.

It is expressly intended that all combinations of those elements that perform substantially the same function in substantially the same way to achieve the same results are within the scope of the invention. Substitutions of elements from one described embodiment to another are also fully intended and contemplated.

1. A method for substantially maximizing picture quality in a video stream transmitted in packets in at least one base layer (105) and at least one enhancement layer (115), said method comprising the steps of:
transmitting said base layer packets (110) for a predetermined time;
transmitting said enhancement layer (115) packets for a time period for a said period determined based on a measure of image quality and channel condition.

2. The method as recited in claim 1, wherein the determined period and the base layer transmission period are less than a critical time period.

3. A method for determining a period for transmitting a video stream comprising a plurality of base layers and corresponding enhancement layers, said method comprising the steps of:
obtaining a measure of channel condition;
transmitting each of said base layers (110) for a predetermined time period; and
transmitting a corresponding enhancement layer (115) for a period (d) determined based on said measure of channel and said base layer time period.

4. The method as recited in claim 3, wherein the base layer time period and the enhancement layer period are less than a critical time period.

5. The method as recited in claim 3, wherein enhancement layer period (d) is selected from a plurality of predetermined values (d₁₁, d₁₂, d₂₂), which are based on measures of selected channel condition (440,450).

6. The method as recited in claim 3, wherein the enhancement layer period is determined from a plurality of predetermined values (d₁₁, d₁₂, d₂₂), which are based on measures of selected channel condition (440,450) and selected base layer time period.

7. The method as recited in claim 6, wherein said enhancement layer period is determined as an interpolated value between two of said plurality of predetermined values (d₁₁, d₁₂, d₂₁).

8. The method as recited in claim 7, wherein said two predetermined values are selected as mathematically adjacent the obtained measure of channel condition.

9. The method as recited in claim 7, wherein said two predetermined values are selected as mathematically adjacent the base layer transmission period.

10. The method as recited in claim 5, wherein the predetermined values (d₁₁, d₁₂, d₂₂) are based on an image quality.

11 The method as recited in claim 10, wherein said predetermined values (d₁₁, d₁₂, d₂₂) are obtained by simulation.

12. The method as recited in claim 10, where said predetermined values (d₁₁, d₁₂, d₂₂) are obtained by actual measurement.

13. An apparatus for determining a period for transmitting a video stream comprising a plurality of base layers (110) and corresponding enhancement layers (115), said apparatus comprising:
a processor (403) in communication with a memory (404), said processor executing code for:
obtaining a measure of channel condition;
transmitting each of said base layers (110) for a predetermined time period; and
transmitting a corresponding enhancement layer (115) for a period determined based on said measure of channel condition and said base layer time period.

14. The apparatus as recited in claim 13, wherein the base layer time period and the enhancement layer period is less than a critical time period.

15. The apparatus as recited in claim 13, wherein said processor executing code for:
selecting said enhancement layer period from a plurality of predetermined values (d₁₁, d₁₂, d₂₂), which are based on measures of selected channel condition (440, 450).

16. The apparatus as recited in claim 13, wherein said processor executing code for:
determining the enhancement layer period from a plurality of predetermined values (d₁, d₁₂, d₂₂), which are based on measures of selected channel condition (440, 450) and selected base layer time period.

17. The apparatus as recited in claim 16, wherein said processor executing code for:
determining said enhancement layer period as an interpolated value between two of said plurality of predetermined values (d₁₁, d₁₂, d₂₂).

18. The apparatus as recited in claim 17, wherein said two predetermined values (d₁₁, d₁₂, d₂₂) are selected as mathematically adjacent the obtained measure of channel condition.

19. The apparatus as recited in claim 17, wherein said two predetermined values (d₁₁, d₁₂, d₂₂) are selected as mathematically adjacent the base layer transmission period.

20. The apparatus as recited in claim 15, wherein the predetermined values (d₁₁, d₁₂, d₂₂) are based on an image quality.

21. The apparatus as recited in claim 20, wherein said predetermined values (d₁₁, d₁₂, d₂₂) are obtained by simulation.

22. The apparatus as recited in claim 20, where said predetermined values (d₁₁, d₁₂, d₂₂) are obtained by actual measurement.

23. The apparatus as recited in claim 15, further comprising:
an input/output device in communication with the memory.

24. The apparatus as recited in claim 15, wherein the code is stored in the memory.
